(19) United States
(12) Patent Application Publication
(10) Pub. No.: US 2020/0111068 A1
(43) Pub. Date: Apr. 9, 2020

(54) Title Registration System and Protocol

(71) Applicant: Bruno Scarselli, New York, NY (US)

(72) Inventor: Bruno Scarselli, New York, NY (US)

(21) Appl. No.: 16/704,017

(22) Filed: Dec. 5, 2019

Related U.S. Application Data
(63) Continuation-in-part of application No. 16/429,784, filed on Jun. 3, 2019.
(60) Provisional application No. 62/679,814, filed on Jun. 2, 2018.

(51) Int. Cl. G06Q 20/06; G06Q 20/36; H04L 9/06; G06Q 30/00

(52) U.S. Cl. CPC G06Q 20/0658; G06Q 30/018; H04L 9/0637; G06Q 20/3678

(57) ABSTRACT

A method for registering title to a precious stone to provide verified ownership information of the precious stone, comprising: a) performing at least one of associating or updating information, including ownership information, with respect to the precious stone on a distributed ledger; and, b) recording the associated and/or updated information on at least one medium, wherein the precious stone has been previously tagged or marked with an identification and that identification has been registered on the distributed ledger.

### RELATED APPLICATIONS

This application claims priority under 35 USC § 120 as a continuation-in-part of pending U.S. patent application Ser. No. 16/429,784 which claims the benefit of priority under 35 USC § 119(e) of U.S. Provisional Patent Application No. 62/679,814, filed on Jun. 2, 2018, the contents of which are incorporated herein by reference in their entireties.

### FIELD AND BACKGROUND OF THE INVENTION

The present invention, in some embodiments thereof, relates to asset management and utilization and, more particularly, but not exclusively, to asset ownership.

### SUMMARY OF THE INVENTION

According to an aspect of some embodiments of the present invention there is provided a method for registering title to a precious stone to provide verified ownership information of the precious stone, comprising: a) performing at least one of associating or updating information, including ownership information, with respect to the precious stone on a distributed ledger; and, b) recording the associated and/or updated information on at least one medium, wherein the precious stone has been previously tagged or marked with an identification and that identification has been registered on the distributed ledger.

In an embodiment of the invention, the method further comprises incorporating the information on at least one of an Internet of Things or cloud-based storage.

In an embodiment of the invention, the method further comprises providing the at least one medium to an owner of the precious stone.

In an embodiment of the invention, the medium is a digital token, a recorded chip or on a portable data storage device.

In an embodiment of the invention, the method further comprises encrypting at least one of the identification or information.

In an embodiment of the invention, the identification is a public key, machine-readable code, a non-fungible token, a fungible token, or human-readable code with magnification.

In an embodiment of the invention, the tagging or marking is performed at a sub-surface site within the precious stone.

In an embodiment of the invention, the tagging or marking is performed on the surface of the precious stone.

In an embodiment of the invention, the distributed ledger is a blockchain

In an embodiment of the invention, the information, in addition to ownership, includes at least one of, name of a buyer or other identity information, means of payment information, bank transaction information, precious stone details, gemological lab certificate number, invoice of sale, payment verification information, physical location of the asset, or custodian of the asset.

In an embodiment of the invention, the method further comprises requiring the provision of a minimum amount of information regarding the precious stone before assigning the precious stone an identification.

In an embodiment of the invention, the method further comprises rating an individual or entity responsible for at least one of tagging, registering, performing, or recording with respect to the precious stone, based on at least one of trustworthiness, accuracy and honesty.

In an embodiment of the invention, the method further comprises verifying ownership information of the precious stone included on the distributed ledger to enable a trust-based transaction involving the precious stone on an online marketplace.

According to an aspect of some embodiments of the present invention there is provided a system for registering title to a precious stone to provide verified ownership information of the precious stone, comprising: a distributed ledger including at least identification information and ownership information associated with the precious stone; and, at least one medium for recording information associated with the precious stone thereon.

In an embodiment of the invention, the system further comprises at least one of an Internet of Things or cloud-based storage for recording information regarding the precious stone thereon.

In an embodiment of the invention, the at least one medium is a digital token, a recorded chip or on a portable data storage device.

In an embodiment of the invention, the identification is a public key, machine-readable code, a non-fungible token, a fungible token, or human-readable code with magnification.

In an embodiment of the invention, the tagging or marking is located at a sub-surface site within the precious stone.

In an embodiment of the invention, the tagging or marking is performed on the surface of the precious stone.

In an embodiment of the invention, the information, in addition to ownership, includes at least one of, name of a buyer or other identity information, means of payment information, bank transaction information, asset details, gemological lab certificate number, invoice of sale, payment verification information, physical location of the asset, or custodian of the asset.

In an embodiment of the invention, the system further comprises at least one reading device for reading at least one of the identification of the precious stone or the at least one medium.

In an embodiment of the invention, the system further comprises an online marketplace wherein ownership information included on the distributed ledger, verified by the at least one reading device, enables a trust-based transaction with the precious stone.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1 is a block diagram showing an exemplary system for title registration;

FIG. 2 is a flowchart showing an exemplary method for registering title to an asset to provide verified ownership information of asset;

FIG. 3 is a flowchart showing an exemplary method of utilizing an asset exchange using verified title information;

FIG. 4 is a schematic of a system for asset identification, registration, tracking and/or commercialization; and,

FIG. 5 is a flowchart of a method of using a system for asset identification, registration, tracking and/or commercialization.

### DESCRIPTION OF SPECIFIC EMBODIMENTS OF THE INVENTION

The present invention, in some embodiments thereof, relates to asset management and utilization and, more particularly, but not exclusively, to asset ownership.

Before explaining at least one embodiment of the invention in detail, it is to be understood that the invention is not necessarily limited in its application to the details of construction and the arrangement of the components and/or methods set forth in the following description and/or illustrated in the drawings and/or the Example. The invention is capable of other embodiments or of being practiced or carried out in various ways.

Unlike many other areas concerning property/tangible-asset ownership, there is no broadly understood and/or utilized method for recording and/or verifying title of diamonds/precious stones/gems and other high value, unique items. In the diamond industry today, typically the only document which may describe ownership or a conveyance of title is an “Invoice of Sale”. This holds true for any level within the diamond industry, for example, investors, brokers, tender houses, manufacturers, retail stores or otherwise cannot receive a verified certificate of title or ownership of the diamond at the time of a transfer of a diamond. The corollary to, and a consequence of, that is that when they in turn sell or otherwise transfer the diamond, they also cannot provide the downstream consumer with any kind of verified certificate of title or ownership.

This industry-wide incapability to provide verified title to evidence ownership of the tradeable asset, in this example a diamond, often leads to unscrupulous actors taking advantage of a system which, from time immemorial, has been based exclusively on trust. Currently, possession signifies ownership of a diamond in the diamond industry, however in reality, possession does not often equate to actual legal ownership.

As a specific and common example in the diamond industry, a consignment or memorandum consents a diamond dealer to provide a diamond or any other valuable luxury item to a third party, the consignment or memorandum allows for the third party to sell the diamond in accordance with the terms and conditions of this document. However, the third party which has physical possession of the diamond could sell the diamond to anyone at any time, and not necessarily in accordance with the terms and conditions of the document. In such situations, because there is no verified certificate of title or ownership, it is practically difficult to report the diamond to any kind of law enforcement or supervising authority as being stolen, sold in an unauthorized manner and/or otherwise handled without the permission of the true owner.

As described herein, systems and related methods are provided which enable trustworthy commercialization and/or trading and/or management of valuable assets such as diamonds, wherein enabling verified ownership/title of the valuable asset(s) facilitates the trustworthiness of transactions involving these assets.

The ownership/title systems and protocols described herein are useful among a large variety of industry levels including the consumer/retail segment, where proper designation/verification of ownership would allow for better insurance programs, as well as private bank financing, rather than currently available and less than favorable financing options which come with very high interest rates and/or other undesirable terms and conditions.

For example, according exemplary aspects of the invention, methods are provided (and related hardware configurations), comprising: a) tagging an asset, such as a gem, transparent or translucent material, polymer, precious stone or crystal, or other assets such as rare books, automobiles, antiques, and other collectibles, with identifying information, where the tagging comprises modification of the asset at a desired location using a tagging unit; b) registering/recording the identifying information, for example using blockchain/distributed ledger technology such as Ethereum, and/or providing a virtual and/or physical verified indicator of ownership; c) subsequent reading of the tag/identification using reading device, such as an automated optical reader like a zoom-capable camera, smartphone, mobile device or microscope; d) updating the recorded information, for example by updating the distributed ledger, based on transactions and/or changes in information relevant to the asset; e) optionally leveraging the integrity/reliability/infallibility of the recorded identifying information of the asset to commercialize and/or otherwise derive benefit from the asset; and wherein many method action steps further include translation/encryption/decryption/processing stages using hardware and/or software.

Generally, it is conceived that asset-recorded blockchain registration information will be read via a reading device (such as a smartphone or other reader), optionally utilizing a cloud-based or Internet-based process, and/or using artificial intelligence (AI), and/or image recognition methods.

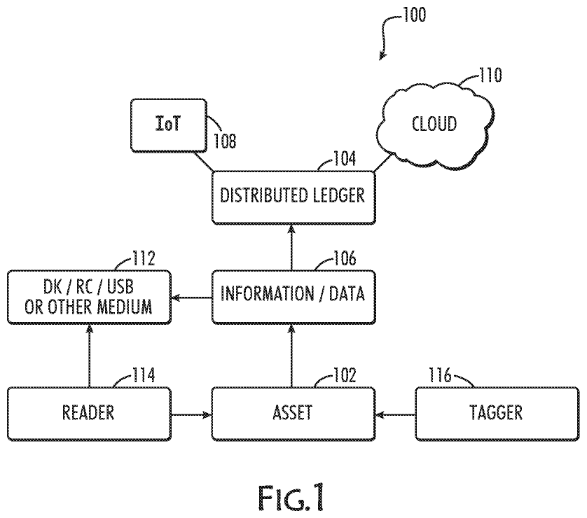

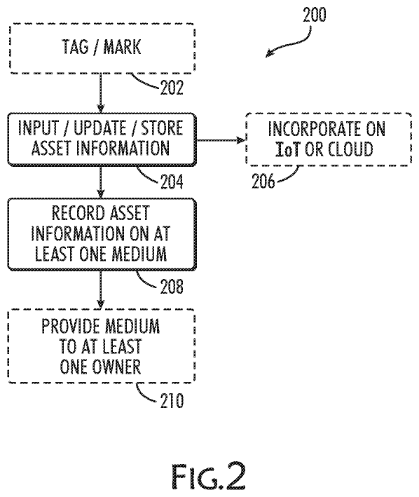

Referring now to the drawings, FIG. 1 is a block diagram showing an exemplary system 100 for title registration of at least one valuable asset 102 and FIG. 2 is a flowchart showing an exemplary method for registering title to an asset to provide verified ownership information of asset. In an embodiment of the invention, the system 100 includes a distributed ledger 104, such as Ethereum, where information 106 regarding the asset 102 is input (204) and/or updated and/or stored (in a distributed manner). Information 106 associated with a specific asset 102 which is stored on the distributed ledger could be additionally, alternatively and/or optionally be incorporated (206) into an Internet of Things (“IoT”) 108 or cloud-based 110 environment to provide, as examples, redundancy, additional access points to the information 106, security and/or enhanced processing and/or communication speed and/or allowing for single or multiple entries should the “diamond” or “asset” be owned by a single or multiple owner(s).

In some embodiments of the invention, information 106 can include, by way of example only:
1). Name of the buyer or other identity information;
2). Driver's license information;
3). Means of payment information;
4). Bank transaction information;
5). Details of asset and other related asset information;
6). Gemological Labs certificate number;
7). Invoice of Sale;
8). Payment Verification information;
9). Bank side transaction information;
10). Passport document information;
11) Physical location of the asset;
12) Current custodian of the asset.

In some embodiments of the invention, title information is recorded (208) in at least one medium, for example using a digital token (“DK”, e.g. registration on a blockchain), on a recorded/recordable chip (“RC”, e.g. on a portable card) and/or on a portable data storage device (e.g. a “USB” thumbnail drive). Optionally, the at least one owner of the asset is provided (210) with at least one of these indicators of ownership, which can be read using a reading device 114. In some embodiments of the invention, the medium includes title/ownership information helps facilitate commercial transactions such as the transfer of share ownership and the payment settlements (or other commercial transactions, examples of which are described elsewhere herein). It should be understood that ownership or multiple party ownership of at least one asset is useful for such organizations as joint ventures, partnerships, estates, funds or is used in a common sale. In some embodiments of the invention, the ownership indicating medium is encrypted. While the reading device 114 is shown in FIG. 1 as possibly being the same device which reads a public key on the asset 102 and reads a private key from an ownership verifying medium 112, it should be understood that these could be two different devices and/or could be located in different locations from one another.

In an embodiment of the invention, the verifiable recordal of ownership/title and/or a tangible and/or verifiable indication of ownership information, allows for a broader communication of owner details, for example, via a NFT “Non-Fungible Token” pre-established template created by the operator of the blockchain. A NFT is a unique data entry into a blockchain that is distinguishable from all other data entries. A NFT cannot be interchanged with other data in the same way that for example, one Bitcoin can be exchanged for any another Bitcoin. Each NFT is unique and identified using a public/private key pair. The public key is a string of 40 characters (e.g. 0x988Ebd2Dc796711F63E91c36cCB7D05E67704b4d) and mathematically linked to a private key which is a different string of 40 characters. In an embodiment of the invention, a prescribed minimum amount of information regarding the asset may be required in order to create/assign an NFT to the asset. For example, provided information will need met at least 6 of 10 criteria to create an NFT.

A private key should not be shared as it allows the information registered to be read by a second party. A key can be expressed as QR barcodes, as an example, which might be easier to be read. Anyone wanting to prove that they own the public key, can “sign” using their private key. The private key is not revealed in the signature process but proves that the signer does in fact control the private key and can transfer the public key (the act representing ownership of the diamond) if the owner so chooses.

Once an asset has been registered (for example, via data recordal on an issued NFT), then any retail customer with a camera and internet connection can read the inscribed public key and verify for themselves whatever data/information has been published to the blockchain (e.g. the asset's characteristics, place-of-origin, and who attested to those characteristics initially). If the description on the blockchain matches the physical characteristics of the asset in hand and the seller is able to sign a message proving/verifying that they control the public key, then the buyer can know with certainty that the holder of the asset is the legitimate owner. This method of on-chain tracking gives everyone an ability to see a history of transfer dates, sale prices, place-of-origin, etc.

As a specific example, this enables tagging (202) a public key (or other form of identification) on a diamond/precious stone/gem, using a tagging device 116, for example as described in the Related Applications, and giving the private key to the owner of the diamond as a “certificate-of-ownership”, whether tangible and/or digital. Such a scenario could be carried out by the Scarselli Diamond Ownership Registration Exchange (SDEX). In some embodiments of the invention, SDEX is an online and on-chain marketplace available to parties at all levels of the diamond trading/commercialization industry, including buyers and sellers, lenders and borrowers, and/or insurers. It is conceived that SDEX will function similarly to a Register or Recorder of Deeds in a U.S. real estate or real property context or the Land Registry in the U.K., but for diamonds, which has heretofore not existed and which has been an impediment for full realization of the commercialization of diamonds. In an embodiment of the invention, SDEX provides registration services and/or the indication of asset (e.g. diamond) ownership for a fee.

In an embodiment of the invention, the certificate-of-ownership is what facilitates primary purchases, secondary market trading, collateralized lending, and/or diamond insurance markets. When an NFT is created, additional data can be recorded into the blockchain that is associated with the NFT/asset such as cut, clarity, color, place-of-origin, etc. It should be understood that this data should be accurate and should come from a trusted entity such as a trusted gemological laboratory (such as GIA®, IGI®), a reputable Internet company, a reputable retail store, and/or the like. That is, in an embodiment of the invention, the information/data associated with the asset/diamond comes from trustworthy and/or verified/verifiable sources.

In an embodiment of the invention, it is conceived that an internal eco-system of interrelated goods and services will be created/offered within SDEX and/or within related marketplaces which revolve or are at least related to the now-enabled ability to verify diamond ownership.

It should also be understood that in some embodiments of the invention, it is conceived that tagging/marking (202) of a diamond and/or registering it with the distributed ledger happens initially to introduce the diamond onto the title registration system, and subsequent transactions involving the diamond do not necessarily utilize re-tagging or re-registration actions but, rather, the information on the distributed ledger regarding the diamond is updated, new information is added, and/or the updated and/or new information is stored in the record on the ledger related to that specific diamond.

In some embodiments of the invention, when a transaction is performed with the asset, for example a sale, a new token or identification could be issued instead of information associated with the old token being input/updated (204).

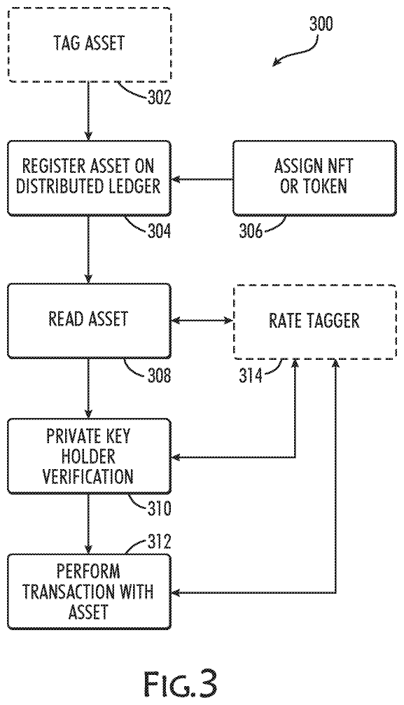

FIG. 3 is a flowchart 300 showing an exemplary method of utilizing an asset exchange using verified title information. In an embodiment of the invention, assets which are tagged (302), such as using methods described herein and in the Related Applications, or otherwise identified and then registered (304) on the distributed ledger/blockchain receive (306) a fungible token or NFT. As described elsewhere herein, the NFT is used, at least in part, to signify ownership of the asset. In an embodiment of the invention, the NFT can represent any percentage of ownership, including full 100% ownership of the asset to a small fraction of the whole. Using NFTs with respect to tagged assets enables first-sale purchases, secondary market trading, collateralized borrowing/lending, and insurance markets for the asset, as just some examples of commercialization scenarios. In some embodiments of the invention, a fungible token is used instead of a non-fungible token, especially in cases where the asset is one of any number of similar or identical assets.

In an embodiment of the invention, public keys are expressed/tagged on the asset as machine-readable codes, such as QR codes or barcodes. Anyone wanting to prove that they own the public key, can sign a message using their private key. The private key is not revealed in the signature process but proves that the signer does in fact control the private key and can transfer the public key (which represents ownership of the diamond) if they so choose. Optionally, the identification is human readable using magnification assistance.

Once the diamond has been tagged and the NFT issued, then any retail customer (or anyone else in the supply/distribution/commercialization chain) with a camera and internet connection can read (308) the inscribed public key and verify for themselves whatever data has been published to the blockchain (e.g. the diamond's characteristics, place-of-origin, and who attested to those characteristics initially). If the description on the blockchain matches the physical characteristics of the diamond in hand and the seller is able to sign a message proving (310) that they control the public key, then the buyer can know with certainty (at least in part because of information relayed back to the reading device) that the holder of the diamond is the legitimate owner and some transaction can be conducted (312) with a certainty of trust with respect to the asset. This method of on chain tracking gives everyone an ability to see a history of transfer dates, sale prices, place-of-origin, etc. It should be understood that diamonds are discussed in the example use above, however, any uniquely identifiable asset (e.g. rare books, automobiles, antiques, coins, stamps, digital/virtual assets like in-game objects, other collectibles) could be used with such a system. Optionally, image recognition is used as an alternative or in addition to tag reading, such as described herein.

This methodology enables all sorts of commercialization scenarios like tagging a public key on a diamond and giving the private key to the owner of the diamond as a certificate-of-ownership. That is, commoditization of unique assets is enabled, which is almost a contradiction in terms. The certificate-of-ownership is what facilitates primary purchases, secondary market trading, collateralized lending, and diamond insurance markets. In an embodiment of the invention, a NFT is created so that additional data can be written into the blockchain that is associated with the asset (in this case a diamond) such as cut, clarity, color, place-of-origin, etc. In some embodiments, assets can be grouped together and/or tokenized together as a group, for commercial activities. In an embodiment of the invention, this additional data should be accurate and should come from a trusted entity, such as Scarselli Diamonds. Embodiments for weighing and/or establishing “trust” is described in more detail below.

In some embodiments of the invention, a user-accessible portal is created for conducting transactions involving tagged, registered and/or tokenized assets. Users can be, for example, laboratories, banks, insurance companies, governmental agencies, retailers, and end-consumers. In an embodiment of the invention, the portal provides and/or receives information related to tagging and/or the assets and enables the verification/validation of this information.

In some embodiments of the invention, when the transaction is performed (312) with the asset, for example a sale, a new token could be issued instead of information associated with the old token being updated.

In an embodiment of the invention, reputation of an asset tagger (the person or entity that initially tags and/or registers an asset on the blockchain) is tracked on the blockchain. Taggers which exhibit dishonesty, inaccuracy or other anomalous behavior can be rated (314) and/or stored on the blockchain. It is conceived that a mechanism can be implemented to financially punish a dishonest tagger by requiring all taggers to post a bond, which would be at least partially forfeit based on an unsatisfactory reputation rating. As for what the “correct” dollar amount is and under what circumstances a tagger's bond is forfeited, a model known as a Token Curated Registry (TCR) can be used, in an embodiment of the invention. A TCR is a decentrally-curated list with intrinsic economic incentives for token holders to curate the list's contents judiciously. In an embodiment of the invention, the “list” consists of “trusted taggers”. This TCR, or a similar concept, can be incorporated as a feature into SDEX, in an embodiment of the invention.

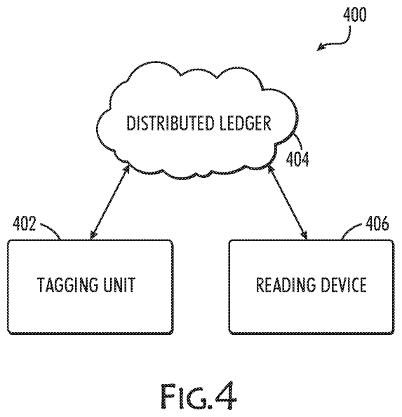

FIG. 4 is a schematic of a system 400 for asset identification, registration, tracking and/or commercialization, in accordance with an embodiment of the invention. As described elsewhere herein, an asset is tagged with identifying information, for example a public key which is usable with respect to the systems and/or protocols of title/ownership registration and verification described herein. In an embodiment of the invention, this tagging is performed by a tagging unit 402 configured to modify the structure, or even surface, of the asset using a laser. In an embodiment of the invention, the tagging unit comprises a laser, using operational parameters such as described herein or in related disclosures such as WO2017/006092, whose operation is directed by a controller and wherein the tagging unit also optionally uses a hardware based encryption/translation operationally linked to corresponding decryption/translation hardware in a reading device. Exemplary tagging unit 403 configurations are also described with respect to U.S. patent application Ser. No. 16/429,784, the disclosure of which is incorporated herein. In some embodiments, software is used instead of or in addition to hardware based encryption/translation. In some embodiments of the invention, software is used to provide the various components of the system are programmed to cooperate through software (such as program code, web-based interfaces, mobile app and/or API).

In some embodiments, at least one component used in the tagging is not physically integrated with the tagging unit, for example the controller and/or encryption/translation processing could be located externally (but for the purposes of this description is still considered to be a part of the “tagging unit”). In some embodiments, instead of or in addition to hardware based encryption/translation, software installed on an external device, like a computer, is used for providing encryption/translation.

In some embodiments of the invention, the tagging unit is configured, for example using a hard-wired and/or wireless connection, for operative communication with a global communications network, such as the Internet or World Wide Web. Wireless communication includes, but is not limited to, Wi-Fi, Bluetooth, and/or IR. The communications connection is used, for example, to register the tagged identification and/or additional information relevant to the asset with a database, server, and/or distributed ledger system 404, such as blockchain. In some embodiments, at least a part of the database, server, and/or distributed ledger system 404 is local. Additionally, alternatively and/or optionally, database, server, and/or distributed ledger system 404 is remotely located and/or is located in a “cloud” type network.

The reading device 406 is configured with hardware and/or software for decrypting/translating registered identification and/or related information retrieved from the distributed ledger about an asset read/scanned by the reading device. In an embodiment, the reading device's hardware and/or software is operationally corresponded to the tagging unit's identification/information output registered with the distributed ledger such that the reading device's hardware and/or software is required to successfully and/or usefully retrieve the asset's identification/information from the distributed ledger. In some embodiments of the invention, the reading device is optically based, for example comprising a microscope, a mobile device (such as the camera of a smartphone or even an optical reading device attached to a smartphone or tablet) and/or a zooming camera. The reading device could be a dedicated, specifically-purposed reader or could be multi-purpose hardware (such as a tablet, smartphone or mobile communication device) programmed with software which programs the multi-purpose hardware with operationally sensitive parameters, such as scanning depth and/or magnification and/or optical character recognition and/or bar/QR code-type reading, for reading the identification etched into the asset. In some embodiments of the invention, the reading device reads the public key associated to the private key and thus, the NFT which identifies the owner(s) of the asset. In some embodiments of the invention, the reading device is sized and/or shaped to be hand held. As with the tagging unit, in some embodiments certain components and/or functions are performed externally to the reading device, but for the purposes of this description are still considered as a part of the “reading device”.

In some embodiments, instead of a reading device being used, the identification is optically and/or manually retrieved and entered into a user-interface, such as a website and/or through a web-based browser/interface, for verifying asset identification and/or retrieving related asset information.

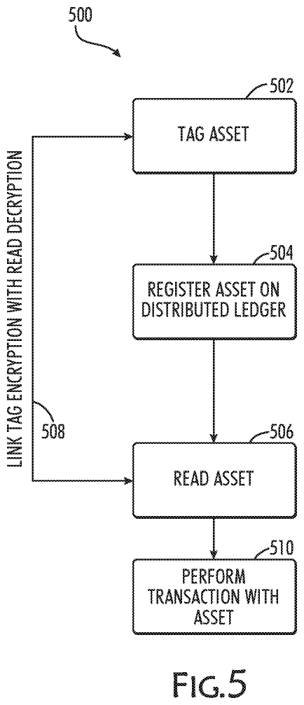

FIG. 5 is a flowchart 500 of a method of using a system for asset identification, registration, tracking and/or commercialization, such as described with respect to FIG. 4. As described elsewhere herein, an asset is tagged (502) by a tagging unit with identification and/or other information such as a public key (where, in an embodiment of the invention, the public key is used to verify ownership), optionally etching the identification/information into and/or onto the structure of the asset using a laser. In some embodiments of the invention, the process of tagging also includes encrypting and/or coding and/or translating the identification and/or information such that special decryption and/or decoding and/or translating the identification and/or information is required in order to acquire useful data from the retrieved identification and/or information. Optionally, the encryption/decryption is achieved using hardware or software or a combination thereof. Optionally, the encryption occurs when communicating the newly etched tag for registration (504) with a distributed ledger, where the ledger uses technology such as blockchain. Optionally, a component of encryption/decryption and/or the identification and/or relevant information includes identifiers/codes/internal tracking numbers attributable to different entities relevant to the asset (e.g. mining company, certification lab (such as GIA®, IGI®), verification lab (such as Gübelin®), identification assignment/registration/verification/reading/tracking company (such as Scarselli Diamonds).

In some embodiments of the invention, identification (506) can be achieved by etching it in a human readable (by using optical magnification devices) and/or machine readable form, such as a number, a bar code, a QR code, and/or the like, any of which could be functional as a public key. Information related to the asset, such as provenance, current and/or past physical locations, current and/or past owners (even as an anonymous owner identified by a code or other similar device), past and/or most recent transactions, grading or certification details, could also be combined, or registered separately but linked, with the identification for registration with the ledger. In some embodiments, the identification and/or information is contributed by a third party, such as a certification lab and/or an authenticity verification lab. It is conceived that the identification of the asset will be immutable; however, information related to the asset could be changed over time. Thus, modifications of the information related to the asset are optionally made by updating the ledger entry for the asset, in some embodiments, using dedicated software and/or hardware for doing so.

In some embodiments of the invention, one aspect of commercialization tied to the presently described systems and methods includes incorporating branding and/or a particular labeling of the asset into the identification and/or related asset information registered with the distributed ledger. For example, the brand (in the form of a numerical code, text, graphic, logo, pattern, etc.) of a particular company could be etched into the asset, optionally forming a part of the identification and/or optionally forming a part of the asset related information.

As described elsewhere herein, a reading device is used to scan the identification etched into the physical asset in order to gather verification of identification and/or related asset information from the ledger. In some embodiments, the reading device is tied by hardware and/or software to the tagging unit, such that decryption of the asset identification/information can only be achieved by a correspondingly linked (508) reading device. In some embodiments, the reading device is a stationary system such as could be found in a gemological lab. In some embodiments, the reading device is portable, for example being a specially-programmed, hand held dedicated reader or a mobile device (tablet, phone, etc.).

It is conceived that the reading device automatically contacts the distributed ledger, for example through a wired or wireless communications connection, in order to retrieve the identification and/or related information of the asset (including optionally decrypting/translating the retrieved data). However, in some situations, the identification is read by the reading device and then a user retrieves the identification verification and/or related information (including optionally decrypting/translating the retrieved data) by inputting the scanned/read identification into a user interface/system which is in operative communication with the distributed ledger.

The ability to reliably track identification and/or information related to a specific physical asset, such as a diamond, enhances the confidence of businesses and the public in the value and traceability of the specific asset. Such an enhancement enables the leveraging (510) of the asset for use in commercial transactions such as sales, use as collateral, monetization, investment, insurance, finance, logistics (e.g. chain of custody) and/or trading and/or for assisting law enforcement (e.g. counterfeiting protection, brand enforcement, asset theft prevention and recovery), wherein any entity (e.g. bank, market, broker, lab, investment house, individual, manufacturer, mining company) within these industries is a potential user of the systems and methods described herein for verification of identification and/or information related to a specific asset, such as ownership/title.

It should also be understood that the retrieval of identification/information about a particular asset can be restricted/limited depending on the entity requesting the information. For example, some or all of these transactions are optionally conducted anonymously (i.e. the ownership information is anonymized or is left out of the information on the ledger or is filtered out of the information on the ledger at retrieval). Further, different entities related to the asset may have different reference numbers or different information for the same asset and therefore, in an embodiment of the invention, some or all of the identification/information related to a specific asset is provided or not provided depending on the entity requesting the information.

In some embodiments of the invention, use of the distributed ledger (for example, blockchain) provides the additional advantage of allowing the tokenization of tagged assets, to indicate and/or track at least ownership aspects. That is, rights to assets which have been tokenized can be stored and managed on a blockchain network. With this method, tangible assets, such as diamonds and other assets described above, can be divided into small units and/or fractional ownership, increasing their liquidity and enabling more market participants to participate in ownership and/or commercialization of the asset. By tokenizing assets, with each physical asset corresponding to one single token, for example one diamond=one token, tagged assets can be traded like a cryptocurrency, managing their value exchange using smart contracts written on the blockchain. Since each single token will represent a unique asset, the value of each token will be different. The value of each token, if converted into fiat money or cryptocurrency will fluctuate, based on the value change of the asset, independently from fluctuations in fiat currencies or cryptocurrencies.

In some embodiments of the invention, an image of the asset or asset tag is used as a confirming verification and/or in lieu of tag verification using the distributed ledger. For example, the reading device is used to acquire an identifying image of the asset or asset tag (e.g. actual image vs. code reading), additionally or alternatively to reading a tag on and/or within the asset (e.g. the tag is located at a sub-surface site inside of the asset). Optionally, the image is super-high resolution and/or at a magnification sufficient for identification of the asset and/or asset tag. In an embodiment of the invention, the acquired image is compared on a database, optionally remotely, to a verifying image of the asset and/or asset tag. In some embodiments, AI is used to assist with the processing and/or comparison of the acquired image. In some embodiments of the invention, image identification information (which is used for the verifying comparison) is linked to the distributed ledger, for example on the blockchain that also includes the asset's tagging information such as described elsewhere herein.

In an embodiment of the invention, the result achieved from verification/validation of the asset, whether by tag or image or both, is communicated back to the reading device.

Some repeated, alternative, additional and/or optional software platforms for and uses of the technologies described herein include:
A. Digital thumbnail of diamonds
   non-erasable immutable embedded tagging identifier will be uploaded to the blockchain and diamond tag readers will automatically pull up the digital thumbnail registered on the blockchain
   Other attributes: Gemological certificate, Picture, Origin, Last Insurance Value, Reference valuation, Ownership Title, Geographical Location, etc.
   Flag stolen diamond
   Flag diamond if not conflict free certified
   Flag diamond if coming from mine that uses child labor
B. API for diamond service providers
Permission based access for suppliers, examples listed herein and below, who can provide services and quotes
   Insurance Companies
   Transportation companies
   Safe deposit box manufacturers
   Vault services
C. B2C Portal
Permission based access to sellers to list diamonds available for sale. This will be a Business to Consumer (B2C) portal in some embodiments of the invention, which are not B2B. Diamond brokerage capability for consumers through Scarselli Diamonds or an affiliate.
D. API for diamond intelligence services
Permission based access for diamond verification, including checking for altered or stolen items
   Insurance companies, checking on potential multiple use of the same diamond as collateral for different loans
   Jewelers for buy-ins
   Law enforcement agencies
E. Diamond Lending Platform
The development of a general lending or peer-to-peer lending platform in the diamond industry to compensate for the diminishing interest by traditional banks, due to the current lack of transparency in the diamond sector.
F. CVD digital thumbnail
Blockchain registration of synthetic diamonds or CVD's (Carbon Vaporized Diamonds)

### EXAMPLE

Reference is now made to the following example, which together with the above description illustrates some embodiments of the invention in a non-limiting fashion. The below example delineates examples of information/data associated with the asset/diamond which is associated with an NFT token registered with SDEX and/or on the blockchain.

At least some of the following information is optionally included:

| | |
|---|---|
| Report Type | Grading Report |
| GIA Report Number | 1237063199 |
| Shape and Cutting Style | Cushion Modified Brilliant |
| Measurements | 8.47 × 8.23 × 5.37 mm |
| Carat Weight | 3.44 carat |
| Color Grade | Fancy Light Yellow |
| Color Origin | Natural |
| Color Distribution | Even |
| Clarity Grade | Internally Flawless |
| Proportions: extremely | |
| thick (faceted) x-axis 54%, y-axis 65.2% | |
| Polish | Excellent |
| Symmetry | Very Good |
| Fluorescence | Faint |

Inscription(s): GIA 1237063199
Comments: Minor details of polish are not shown.
internal numerical code “8675309”

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for registering title to a precious stone to provide verified ownership information of the precious stone, comprising:
a) performing at least one of associating or updating information, including ownership information, with respect to the precious stone on a distributed ledger; and,
b) recording the associated and/or updated information on at least one medium,
wherein the precious stone has been previously tagged or marked with an identification and that identification has been registered on the distributed ledger.

2. The method according to claim 1, further comprising incorporating the information on at least one of an Internet of Things or cloud-based storage.

3. The method according to claim 1, further comprising providing the at least one medium to an owner of the precious stone.

4. The method according to claim 3, wherein the medium is a digital token, a recorded chip or on a portable data storage device.

5. The method according to claim 1, further comprising encrypting at least one of the identification or information.

6. The method according to claim 1, wherein the identification is a public key, machine-readable code, a non-fungible token, a fungible token, or human-readable code with magnification.

7. The method according to claim 1, wherein the tagging or marking is performed at a sub-surface site within the precious stone.

8. The method according to claim 1, wherein the tagging or marking is performed on the surface of the precious stone.

9. The method according to claim 1, wherein the distributed ledger is a blockchain.

10. The method according to claim 1, wherein the information, in addition to ownership, includes at least one of, name of a buyer or other identity information, means of payment information, bank transaction information, precious stone details, gemological lab certificate number, invoice of sale, payment verification information, physical location of the asset, or custodian of the asset.

11. The method according to claim 1, further comprising requiring the provision of a minimum amount of information regarding the precious stone before assigning the precious stone an identification.

12. The method according to claim 1, further comprising rating an individual or entity responsible for at least one of tagging, registering, performing, or recording with respect to the precious stone, based on at least one of trustworthiness, accuracy and honesty.

13. The method according to claim 1, further comprising verifying ownership information of the precious stone included on the distributed ledger to enable a trust-based transaction involving the precious stone on an online marketplace.

14. A system for registering title to a precious stone to provide verified ownership information of the precious stone, comprising:
a distributed ledger including at least identification information and ownership information associated with the precious stone; and,
at least one medium for recording information associated with the precious stone thereon.

15. The system according to claim 12, further comprising at least one of an Internet of Things or cloud-based storage for recording information regarding the precious stone thereon.

16. The system according to claim 12, wherein the at least one medium is a digital token, a recorded chip or on a portable data storage device.

17. The system according to claim 12, wherein the identification is a public key, machine-readable code, a non-fungible token, a fungible token, or human-readable code with magnification.

18. The system according to claim 12, wherein the tagging or marking is located at a sub-surface site within the precious stone.

19. The system according to claim 12, wherein the tagging or marking is performed on the surface of the precious stone.

20. The system according to claim 12, wherein the information, in addition to ownership, includes at least one of, name of a buyer or other identity information, means of payment information, bank transaction information, asset details, gemological lab certificate number, invoice of sale, payment verification information, physical location of the asset, or custodian of the asset.

21. The system according to claim 12, further comprising at least one reading device for reading at least one of the identification of the precious stone or the at least one medium.

22. The system according to claim 21, further comprising an online marketplace wherein ownership information included on the distributed ledger, verified by the at least one reading device, enables a trust-based transaction with the precious stone.
